(19) United States
(12) Patent Application Publication
(10) Pub. No.: US 2025/0375974 A1
(43) Pub. Date: Dec. 11, 2025

(54) DEVICE FOR PRINTING ON GLASS, MACHINE FOR PRINTING ON GLASS AND METHOD FOR PRINTING ON GLASS

(71) Applicant: SAINT-GOBAIN GLASS FRANCE, COURBEVOIE (FR)

(72) Inventors: Maxime LE BAIL, COURBEVOIE (FR); Leila DUMOTIER, THOUROTTE CEDEX (FR)

(21) Appl. No.: 18/873,039

(22) PCT Filed: Jun. 7, 2023
(86) PCT No.: PCT/FR2023/050801

§ 371 Date: Dec. 9, 2024

(30) Foreign Application Priority Data
Jun. 9, 2022 (FR) FR2205532

(51) Int. Cl. B41J 25/00; B41J 11/00; B41J 25/304

(52) U.S. Cl. CPC B41J 25/001; B41J 11/002; B41J 25/304

(57) ABSTRACT

A device for printing on glass includes a holder configured to receive a glass article, at least one six-axis robot, a printing tool including at least one print head, a speed sensor configured to detect the relative printing speed of the at least one print head relative to a surface of the glass, a distance-maintaining system configured to maintain a constant distance between the at least one print head and the surface of the glass and a control system configured to control the movements of the robot, adjust the speed of movement of the at least one print head depending on the relative printing speed and adjust the distance between the at least one print head and the surface of the glass.

The present invention relates to the field of printing, and more particularly to a device for printing on glass, a machine for printing on glass and a method for printing on glass.

Digital printing (also known as inkjet printing) is commonly used for depositing coatings on flat glass articles in two dimensions. In this case, the glass usually moves on rollers or on a conveyor belt at a constant altitude. The print heads move over the glass at a distance of between 0.5 and 3 mm from the glass at a constant altitude, making it easy to maintain a constant distance between the print heads and the glass. During printing, the glass and/or the print heads move along the X and Y axes at constant speed. For reasons of cycle time savings, the coating is preferentially deposited in a single pass, meaning that the print head passes over each point on the glass only once, as opposed to multi-pass.

For applications such as digital printing on automotive glass, such as for example windshields, printing is carried out on the flat glass, before any bending or laminating step. The glass only takes on its final three-dimensional shape once the printing process has been completed, at the end of the bending step. For this reason, the inks used are ceramic- or enamel-based ink, and must be able to withstand temperatures in excess of 600° C., which are encountered during subsequent three-dimensional glass shaping steps (bending, laminating). In addition, for some applications, several ink curing steps are required, notably to develop specific ink properties such as anti-stick.

The digital printing coating method can be applied to three-dimensional everyday objects made of glass or other materials. These objects are generally cylindrical in shape, for example bottles, glasses, flasks, etc. These objects are then rotated along their axis of symmetry while a print head scrolls over the object, perpendicular to this axis of rotation.

A device for decorating the outer surface of objects containing beverages using digital printing is thus known from U.S. Pat. No. 10,933,626B1. The object to be decorated is cylindrical. A device allows the object to be decorated to be rotated along the axis of symmetry thereof at the speed of one's choice. A turret-type device is equipped with digital printing stations and ink drying stations arranged in an arc of a circle above the part to be printed. The turret-type device allows the desired station to be brought above the object to be printed while the latter rotates on itself in order to carry out digital printing.

Patent application US20130222498A1 describes a machine for depositing ceramic-type ink on flat glass by digital printing. The glass is placed horizontally on the machine table. The digital print head is attached to a ramp above the glass and moves thereover to cover the entire surface thereof. The machine is equipped with a system for drying the ink so that the glass can subsequently be moved towards a firing furnace for shaping. FR3009235A1 describes a system for orienting a series of print heads at different angles. In a first configuration, the four heads are parallel to each other, oriented in the same direction in order to print a flat surface. The invention then allows the four heads to be oriented at a specific angle each so as to orient them in an arc of a circle, allowing printing on the concave face of a cylindrical object and adapting to the radius of curvature thereof. This patent describes a system wherein the print heads are tiltable but with a limited number of positions and configurations.

PCT international application publication WO2013143659A1 describes a method for decorating a three-dimensional object by digital printing using a print head carried by a six-axis robot. This invention describes a step for scanning the surface to be printed, allowing a set of points to be generated constituting the trajectory to be covered by the robot in order to carry out digital printing as well as a digital printing step using the print head.

Patent application US2021300061A1 describes a process for decorating three-dimensional objects allowing digital printing onto three-dimensional objects using a machine equipped with a six-axis robot. This robot transports three-dimensional objects in front of fixed digital print heads.

When performing deposition by digital printing on a surface, droplets are ejected towards the surface to be printed. Due to the size of the droplets, a few picoliters (pL), and in order to ensure a homogeneous deposit that respects the shape of the image to be printed, it is essential to maintain a constant distance between the surface to be printed and the print head at all times, as well as a constant relative speed between the print head and the surface to be printed.

Furthermore, in the case of windshields, the ink is printed on flat glass before bending, using exclusively ceramic inks. The ink is exclusively ceramic, and not organic since the glass is then shaped in a bending furnace at temperatures in excess of 600° C., which limits the number of ink references that can be used. In addition, these inks must have anti-stick properties in the case of face 2 or face 3 applications, which further restricts the range of inks that can be used. Before laminating, laminated glass consists of two glass articles, each comprising two sides, which defines a four-sided system:
face 1 corresponds to the face that will be on the exterior of the vehicle for automotive glazing,
face 2 corresponds to the face directly opposite face 1 and on the same glass before lamination and in contact with the interlayer (for example PVB (polyvinyl butyral)),
face 3 corresponds to the face in contact with the other side of the interlayer, and
face 4 corresponds to the face directly opposite face 3 and located on the same glass before lamination, and is also the face that will be located inside the vehicle, in direct contact with the passenger(s) of the vehicle.

Finally a specific ink pre-curing step is required, which increases energy consumption for each windshield manufactured, as well as generating quality defects on the glazing.

Furthermore, examples of digital printing on three-dimensional (3D) objects, whether glass or not, are limited to objects having an axis of symmetry and large radii of curvature, for example bottles, flasks, baseball bats, etc. In this case, during the printing phase, the objects are rotated along this axis of symmetry. The print head moves over the rotating object, parallel to the axis of rotation thereof. Thus, this ensures a uniform speed for both the rotating object and the print head and printing takes place virtually on a flat surface. This configuration cannot be applied to large glass articles such as skylights or windshields.

Lastly, although commercially available six-axis robots operating in the “workpiece-carrying” mode guarantee high spatial precision, namely systematic passage through the same points over a path or trajectory, they do not guarantee temporal precision, that is passage at a rigorously constant speed over the entire path. Very sudden and rapid fluctuations around the setpoint speed of +/−10% are observed. Thus in the digital printing type application, where the print heads adapt the drop ejection frequency to the setpoint speed applied to the robot and not to the actual speed of the robot at any given moment, it is possible to observe defects in the patterns printed with this method, with some drops being ejected too early onto the glass, and others too late due to speed variations. The result is faulty dot placement, as well as areas with too much ink and areas with too little ink.

There is therefore a need for a device, a machine and a method for printing on glass that allow precise and controlled printing, guaranteeing a homogeneous and long-lasting deposition on objects of varying geometries.

The Applicant therefore proposes to meet these needs by using a device, a machine and a method implementing a six-axis robot allowing print heads to be tilted according to an infinite number of positions and configurations, a device for real-time measurement of print head speed relative to the object to be decorated, and means for maintaining the distance between the print head and glass.

The objective of the present invention is therefore a device for printing on glass, characterized in that it comprises:
a holder configured to receive a glass article on at least one surface of which printing is to be performed;
at least one robot configured to move an arm along six axes, the arm having one end connected to a base and an opposite free end;
a printing tool, the printing tool comprising at least one print head configured to be mounted on the free end of the arm of the at least one robot;
a speed sensor, configured to detect the relative printing speed of the at least one print head relative to the at least one glass surface;
distance-maintaining means, configured to maintain a constant distance between the at least one print head and the at least one glass surface;
control means configured to control the movements of the at least one robot, adjust the speed of movement of the at least one print head depending on the relative printing speed and adjust the distance between the at least one print head and the at least one glass surface via the distance-maintaining means.

Thus, a device of this type can, together and in real time, detect the relative speed of the at least one print head relative to the glass surface and maintain a constant distance between the at least one print head and the glass surface. The printing is reliably reproducible even if there are differences in shape (curve) and thickness between two glass articles.

Additionally, real-time detection of the relative speed of at least one print head relative to the glass surface allows print head movement speeds of at least 200 mm/s and the combination of relative speed detection and distance maintenance leads to very short cycle times to reduce printing time, which is particularly advantageous in the field of automotive glass production (between 20 and 40 s/glass).

Additionally, the speed sensor compensates for the lack of temporal precision of the six-axis robots, during the first realization of each trajectory, by measuring in real time the instantaneous relative speed of the at least one print head relative to the glass. This measurement is then transmitted to the at least one print head which adapts its droplet ejection frequency in real time depending on where it is located above the glass. This improves droplet deposition accuracy and reduces printing defects.

The device for printing on glass according to the present invention allows the glass to be held stationary during printing, the at least one print head being mobile and moving over the glass.

The device for printing on glass according to the present invention allows ink to be printed after the glass shaping step. The use of a six-axis robot allows print heads to be tilted according to an infinite number of positions and configurations. Thus, the device for printing on glass according to the present invention is particularly suitable for printing on objects with a wide variety of geometries and thus allowing decorations to be created on glass such as windshields or skylights, or else when the entire surface is to be decorated.

Additionally, since the three-dimensional glass shaping steps can be carried out after printing, there are fewer constraints on inks, and a wider choice of inks is therefore available.

In one embodiment, the at least one print head is a fast loading and unloading print head, for example pneumatic or magnetic. For example, Schunk® robot tool changers thus allow a rapid tool change on a robot head.

Thus, it is possible to successively print different ink references with minimum loss of time.

According to one embodiment, the distance-maintaining means are at least one of a system for constraining the glass according to a predetermined shape, preferably by suction cups, a system for scanning the glass surface to record the shape thereof and a distance sensor carried by the printing tool.

According to one embodiment, the control means consist of at least one of a microcontroller, a processor, a microprocessor, a digital signal processor (DSP), a field-programmable gate array (FPGA), an application-specific component (ASIC), a computer, comprising software configured to control the robot, the printing tool and the distance-maintaining means.

According to one embodiment, the at least one robot is configured to move the at least one print head in an adjacent strip scanning pattern, preferably moving continuously in two different directions over two adjacent strips to reduce printing time. The result is thus continuous printing, without unnecessary movement of the at least one print head.

According to one embodiment, the device for printing on glass comprises a single robot and a gantry, the robot being attached by its base to the gantry so that the base is arranged above the holder.

According to one embodiment, the device for printing on glass comprises two robots, with the robot bases being preferably arranged at the same height as the holder and on either side of the holder.

According to one embodiment, each robot prints on one half of the at least one surface of the glass.

According to one embodiment, the device for printing on glass further comprises at least one additional print head and means for changing the at least one print head configured to replace the at least one print head with the at least one additional print head, preferably by pneumatic or magnetic loading and unloading.

Thus, the means for changing allow different colors or inks to be printed on the same glass article with a single device for printing on glass, and also allow an ink A to be printed on glass type A′ and an ink B to be printed on glass type B′. Finally, in the event of maintenance on a print head, one print head remains operational, ensuring continuous and uninterrupted operation of the machine.

Another object of the present invention is a machine for printing on glass, characterized in that it comprises, successively arranged:
a glass loading station;
a glass washing station;
an optional glass scanning station;
a glass surface preparation station;
a printing station equipped with a device for printing on glass as described above;
a drying station;
a control station;
an unloading station; and
two adjacent stations being connected by glass conveying devices, preferably rollers or a conveyor belt.

Thus, the use of several modular stations allows the machine to operate sequentially and to process several glass articles at a time. The configuration of the printing station is modular as it can be equipped with several robots to reduce the cycle time.

According to one embodiment, the machine further comprises a post-treatment station between the drying station and the control station.

Another object of the present invention is a method for printing on glass implementing a device for printing on glass as described above, characterized in that it comprises:
loading the holder with a glass article on at least one surface of which printing is to be carried out;
printing on the surface of the glass article;
unloading the printed glass article.

To better illustrate the object of the present invention, several embodiments are described below, by way of illustration and without limitation, with reference to the appended drawings.

On these drawings:

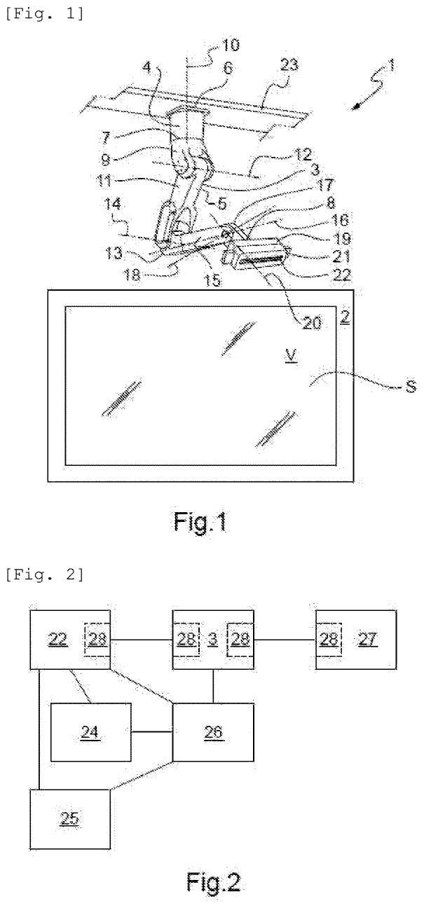

FIG. 1 is a perspective view of a device for printing on glass according to a first embodiment of the present invention;

FIG. 2 is a schematic representation of the device for printing on glass according to FIG. 1;

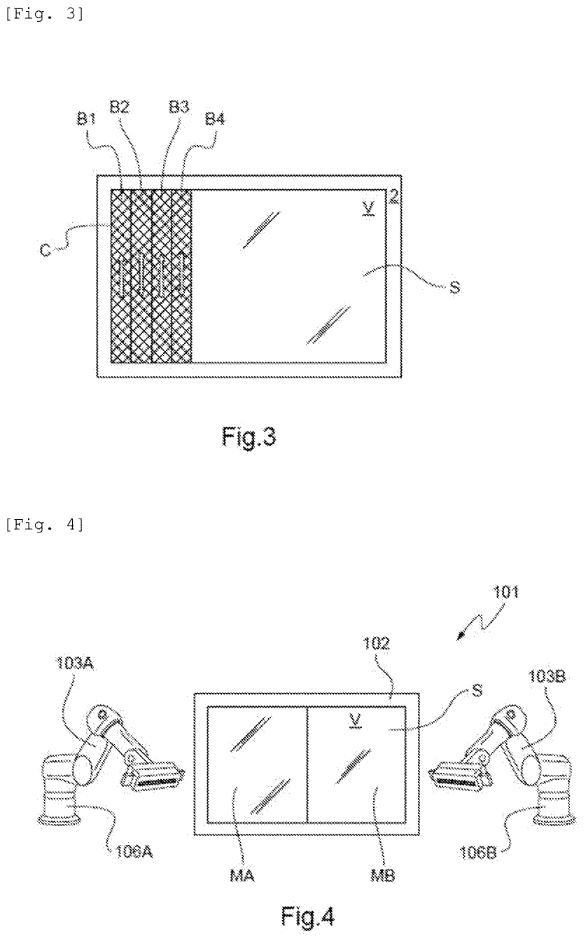

FIG. 3 is a top view of a glass printed by the device for printing on glass of the present invention according to a scanning pattern;

FIG. 4 is a perspective view of a device for printing on glass according to a second embodiment of the present invention; and

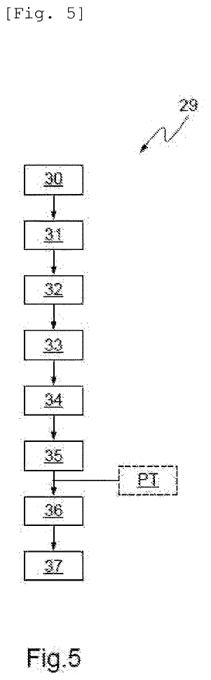

FIG. 5 is a schematic representation of a machine for printing on glass according to the present invention.

Referring to FIG. 1, it can be seen that it shows a device for printing on glass 1 according to a first embodiment of the present invention.

The device for printing on glass 1 comprises a holder 2. The holder 2 may be any holder for printing known to the skilled person suitable for receiving an object on which printing is to be performed. The holder 2 may be fixed. In this case, handling tools will load the latter with the glass V on which printing is to be performed. The holder 2 may be mobile such as for example be arranged on a conveyor.

The device for printing on glass 1 also comprises a robot 3. The robot 3 is a six-axis type robot. As can be seen from FIG. 1, and as is well known to those skilled in the art, the robot 3 comprises a base 4 and an articulated arm 5.

The base 4 has a flat mounting face 6 by which the base 4 can be mounted on an external frame.

The arm 5 comprises a proximal end 7 connected to the base 4 and a free distal end 8, opposite the proximal end 7. The proximal end 7 of the arm 5 is connected to the base 4 by a shoulder 9. The shoulder 9 is rotatable relative to the base 4, along a first axis 10 perpendicular to the mounting face 6.

The arm 5 comprises an upper arm 11. The upper arm 11 is pivotally connected to the shoulder 9 along a second axis 12 perpendicular to the first axis 10.

The arm 5 comprises an elbow 13. The elbow 13 is pivotally connected to the upper arm 11 along a third axis 14 parallel to the second axis 12.

The arm 5 comprises a forearm 15. The forearm 15 is rotatable relative to the elbow 13 along a fourth axis 16 perpendicular to the third axis 14 and extending in the longitudinal direction of the forearm 15.

The arm 5 comprises a first wrist 17. The first wrist 17 is pivotally connected to the forearm 15 along a fifth axis 18 parallel to the third axis 14.

The arm 5 comprises a second wrist 19, at the distal end 8 of the arm 5. The second wrist 19 is rotatably connected to the first wrist 17 along a sixth axis 20 perpendicular to the fifth axis 18.

Thus, the robot 3 is configured to move the arm 5 along six axes.

The device for printing on glass 1 also comprises a printing tool 21.

In FIG. 1, it can be seen that the printing tool 21 comprises a print head 22, mounted at the distal end 8 of the arm 5, on the second wrist 19. It goes without saying that the person skilled in the art will be able to select any print head adapted to the requirements of the printing to be performed, such as for example the number and type of nozzles and the arrangement thereof.

It should further be noted that the person skilled in the art will likewise be able to select any printing tool suited to the needs of the printing to be performed, in particular any necessary configurations and equipment, such as for example feed pipes, an ink tank and a 24-hour ink recirculation system, which remain stationary. These will not be described in detail herein.

According to the first embodiment shown in FIG. 1, the robot 3 is positioned above the holder 2. To do this, the robot 3 is mounted on a gantry 23 such that the mounting plane 6 is parallel to the holder 2. Preferably, the device for printing on glass 1 is configured such that during printing, the center of the base 4 is vertical to the center of the surface S of the glass V on which printing is to be performed. During printing, the arm 5 of the robot 3 is extended towards the glass V below.

It should be noted that the device for printing on glass 1 according to the present invention is suitable for printing on several surfaces of the same glass article, for example on both sides of a windshield.

Below each print head 22, a low-power UV lamp can be found to freeze the ink droplets without drying them completely so as to avoid drips until the entire surface S of the glass V has been printed. This UV lamp must be properly oriented to avoid any reflection of UV rays towards the print head 22, which would lead to polymerization of the ink on the surface of the print head 22. An analogous system of IR pinning for IR inks or hot-air pinning for thermal inks is also conceivable.

As can be seen from the schematic representation in FIG. 2, the device for printing on glass 1 comprises a speed sensor 24, configured to detect the relative printing speed of the print head 22 relative to the surface S of the glass V on which printing is to be performed.

Preferably, the speed sensor 24 is located close to the print head 22, or even directly on the print head.

The device for printing on glass 1 also comprises distance-maintaining means 25, configured to maintain a constant distance between the print head 22 and the surface S of the glass V on which printing is to be performed.

The distance-maintaining means 25 are at least one of a system for constraining the glass according to a predetermined shape, preferably by suction cups, a system for scanning the glass surface to record the shape thereof and a distance sensor carried by the printing tool 21.

Thus, for example, in the first variant of a glass constraining system, a frame fitted with suction cups can constrain a glass article very precisely according to a predetermined shape and on the basis of which the movement of the at least one print head is pre-programmed.

According to the second variant, each glass article is scanned by a shape detection tool (laser scan, camera with image processing software) to precisely determine the shape of each glass article and adapt the path of the at least one print head accordingly.

According to the third variant, a distance sensor, which can be carried by the robot, the at least one print head, or another means (camera with image processing software) calculates in real time the distance between the at least one print head and the glass surface to adapt the path accordingly of the at least one print head to always maintain a predetermined distance between these two elements.

The device for printing on glass 1 also comprises control means 26. The control means 26 are connected to the robot 3, the print head 22, the speed sensor 24 and the distance-maintaining means 25. The control means 26 are configured to control the movements of the robot 3, adjust the speed of movement of the print head 22 depending on the relative printing speed detected by the speed sensor 24, and adjust the distance between the print head 22 and the surface S of the glass V on which printing is to be performed via the distance-maintaining means 25. The control means 26 are also configured to control printing according to a predefined scanning pattern.

The control means 26 consist of at least one of a microcontroller, a processor, a microprocessor, a digital signal processor (DSP), a field-programmable gate array (FPGA), an application-specific component (ASIC), a computer, comprising software configured to control the robot 3, the printing tool 21 and the distance-maintaining means 25.

In FIG. 2, it can be seen that the printing device 1 may, additionally and optionally, comprise an additional print head 27. The additional print head 27 is a spare head for the same or different inks, for example different colors or different structures, natures or constitutions. Advantageously, the additional print head 27 may be stored on a storage rack. Advantageously, the print heads 22, 27 are of the fast loading and unloading type, for example of the pneumatic or magnetic type.

In this case, the device for printing on glass 1 is equipped with means 28 for changing the print head, configured to replace the print head 22 mounted at the distal end 8 of the arm 5 with an additional print head 27. The means 28 for changing the print head are of the type well known to the skilled person, preferably by pneumatic or magnetic loading and unloading.

The replaced print head 22 can be placed on a storage rack.

It should be noted that the person skilled in the art will be able to determine the number of additional print heads required for the printing operation to be performed as well as the number and nature of the means 28 for changing the print head.

During the printing phase, the glass V is stationary; all movements are performed by the robot 3. The trajectory of the robot 3 is adapted according to the information gathered during a previous step of scanning the surface S of the glass V. The robot 3 deploys to bring the print head 22 close to the surface S of the glass V, parallel to this surface S. The print nozzles are oriented towards the glass, for example at a distance of between 1 and 3 mm so as to cover it completely, and permanently perpendicular to the curve of the glass V. The trajectory followed by the print head 22 carried by the robot 3 allows ink to be deposited over the entire surface S of the glass V if required, while adapting to the shape and curve of the glass V so as to maintain a constant distance between the glass V and the print head 22, by virtue of the distance-maintaining means 25.

Referring to FIG. 3, it can be seen that it shows a top view of the surface S of the glass V printed by the device for printing on glass 1 of the present invention according to a scanning pattern. The scanning pattern is in adjacent strips, with the print head 22 preferably moving continuously in two different directions, indicated by the arrows, over adjacent strips B1, B2, B3, B4. The print head 22 moves over the glass V carried by the holder 2, directed by the robot 3 so as to constantly orient the print nozzles perpendicular to the surface S, in particular to the curve of the glass V when the glass to be printed is curved. The print head 22 is able to print patterns across the entire width thereof, corresponding to a strip B1, B2, B3, B4, regardless of the direction in which it moves over the glass V. Thus, it is possible to run a first strip B1 over the length of the glass V, parallel to edge C. At the end of strip B1, the robot 3 allows the print head 22 to rotate 180° C. and shift a width of the print head 22 in order to quickly print a second strip B2, in the opposite direction to the first strip B1. It may be conceivable that printing on the glass V is triggered by an optical device upstream of the print head 21, allowing the edge C of the glass V to be recognized. The reduction in the number of unnecessary movements guarantees a reduction in glass processing time.

It should be noted that the person skilled in the art will be able to define the scanning pattern adapted to the needs of the printing to be performed. For example, the scanning pattern may comprise a return to the starting edge of the strip at the end of printing of the strip.

Since there may be gaps of up to 3 mm between two 3D-formed glass articles of the same type, for example, two successive glass articles of the same type are not identical and therefore do not support the same print head settings which may be optimal for one glass article and lead to an offset, or even contact between the print head and the surface, for another glass article. In order to remedy this, the following solutions may be envisaged: 3D scanning of the glass surface before printing; print head equipped with a confocal or laser triangulation distance sensor to adjust the distance in real time; glass shape restraint, using suction cups for example.

The deposition on the glass V may be continuous or localized.

Referring to FIG. 4, it can be seen that it shows a device for printing on glass 101 according to a second embodiment of the present invention.

The device for printing on glass 101 is similar to the device for printing on glass 1 according to the first embodiment described above. The elements of the device for printing on glass identical or similar to the elements of the device for printing on glass 1 of the first embodiment, and described with reference to FIG. 1, will bear the same reference number increased by 100, and will not be described in more detail herein.

The device for printing on glass 101 according to the second embodiment comprises two robots 103A and 103B.

The respective bases 106A and 106B of the robots 103A and 103B are arranged at the same height as the holder 102 and on either side of the holder 102. However, this example is illustrative and the skilled person will understand that the robots can take any shape and any arrangement, as long as they cover the surface of the glass allocated thereto, depending on the space constraints available.

By virtue of this configuration, each robot 103A and 103B performs printing on one half MA, MB of the surface S of the glass V.

The present invention thus allows different robot/ink combinations, such as: one robot 3, 103A, 103B, one ink; one robot 3, 103A, 103B, two inks; two robots 3, 103A, 103B, one ink or else two robots 3, 103A, 103B, two inks.

It should be noted that any number of robots and print heads may be employed by the person skilled in the art in the device for printing on glass according to the present invention, depending on the requirements of the printing to be performed, without departing from the scope of the present invention.

Referring to FIG. 5, it can be seen that it shows a diagram of a machine for printing on glass 29 according to the present invention.

The machine comprises, arranged in succession: a glass loading station 30, a glass washing station 31, a glass scanning station 32 which is optional, a glass surface preparation station 33, a printing station 34 equipped with a device for printing on glass 1, 101 as described above, a drying station 35, a control station 36 and an unloading station 37. The machine 29 also comprises means for conveying the glass between two adjacent stations 30, 31, 32, 33, 34, 35, 36, 37.

Advantageously, the machine 29 further comprises a post-treatment station between the drying station 35 and the control station 36, for example for post-printing deposition of an adhesion primer, in order to maximize adhesion between the glass and the polyvinyl butyral (PVB) interlayer in the manufacture of laminated glass.

The machine 29 may comprise a computer to control the whole process, synchronize steps and share information.

The machine 29 is able to work sequentially, which means that a different glass is simultaneously in each station 30, 31, 32, 33, 34, 35, 36, 37 and undergoes the step of the process associated with the station. All glass articles are transferred to the next station simultaneously. This means that the cycle time of the machine 29 corresponds to the cycle time of the longest process step.

If required, the glass V is first bent using the usual bending processes. At the end of this step, the 3D glass V is conveyed to the printing machine 29.

At the glass loading station 30, the glass V is loaded onto the machine 29, onto a conveyor, onto a trolley or via a robot responsible for taking it from station to station, constituting the glass conveying means.

At the glass washing station 31, the machine 29 comprises a washing machine for washing a glass article V in 3D. This step may be optional if the printing process is positioned directly at the outlet of the 3D washing machine, prior to assembly with the PVB type interlayer.

At the glass scanning station 32, the machine 29 comprises a scanner for recognizing and acquiring the exact dimensions, positioning and curvature of the glass V. This information is then transmitted to the robot 3, 103A, 103B used during the printing phase, at the printing station 34, so that it can adapt the trajectory thereof to the actual dimensions of each glass V. Recognition of the format of the glass V also allows automatic selection of the printing process to be applied.

At the glass surface preparation station 33, it is possible to deposit an adhesion primer-type coating or a plasma or corona-type surface treatment.

At the drying station 35, drying can be performed using UV lamp(s). The UV lamps are arranged on an articulated rail that can be moved vertically. The width of the UV lamps makes it possible to dry the entire width of the glass V simply by moving the glass V under the row of UV lamps. The speed at which the glass V moves can be modulated, as can the vertical distance between the lamps and the glass V, so as to adapt the UV dose received by each type of glass.

The control station 36 can be equipped with a camera for visual inspection of the glass V and detection of any defects. If the part has no defects, it is unloaded at the outlet of the machine. Otherwise, it is directed towards glass recycling.

Between the printing station and the drying station, the machine 29 may comprise a station configured for visual inspection prior to the drying stage in order to easily remove a coating if necessary.

A specific station may also be provided to run the glass V through the production cycle again, in the event of defects during the printing phase (ink cleaning, ink burnt in a high-temperature furnace, glass transformed into cullet, etc.).

Finally, the present invention relates to a method for printing on glass implementing a device for printing on glass 1, 101 as described above. The method comprises the steps of loading the holder S with a glass article V on a surface of which printing is to be performed, printing the surface S of the glass V by the device for printing on glass 1, 101 as previously described and unloading the printed glass.

The printing step may comprise scanning the surface S according to a pattern of scanning adjacent strips as described above.

The present invention allows ink to be printed directly onto a glass article V in 3D, after the step of bending the glass V and has the following advantages:
energy savings and improved yields by eliminating the ink pre-curing step in the case of one face two or one face three applications;
the ink is no longer required to have anti-stick properties, as the glass articles are bent before the ink is printed;
the range of inks that can potentially be used is wider as the invention allows the use of organic digital inks, which are more common than ceramic digital inks;
the risk of optical distortion is reduced because there is no ink on the glass during bending;
reduced risk of glass breakage for the same reasons as above;
ink deposition either before or after the lamination step in the case of face one or face four deposition;
the option to produce individual or customized designs without changing tooling or screens as in screen printing;
improved deposition precision through real knowledge of the speed at which the glass moves relative to the print heads.

The present invention is particularly suited to all types of glass for the automotive or construction markets, especially non-flat glass articles.

It is understood that the embodiments just described are indicative and non-limiting and that further embodiments may be added without departing from the scope of the present invention.

Thus, although the glass shown in the figures is flat, it is understood that the invention is not limited in this respect and that the device, machine and method of the invention find application when the glass already has a three-dimensional shape.

Similarly, for the sake of simplicity, only one print head per robot is shown in the figures. The invention is still not limited in this respect, and a robot according to the invention may simultaneously carry several print heads, without departing from the scope of the present invention.

1. A device for printing on glass, comprising:
a holder configured to receive a glass article on at least one surface of which printing is to perform;
at least one robot configured to move an arm along six axes, the arm having one end connected to a base and an opposite free end;
a printing tool comprising at least one print head configured to be mounted on the free end of the arm of the at least one robot;
a speed sensor, configured to detect a relative printing speed of the at least one print head relative to the at least one surface of the glass;
distance-maintaining means, configured to maintain a constant distance between the at least one print head and the at least one surface of the glass;
control means configured to control movements of the at least one robot, adjust the speed of movement of the at least one print head depending on the relative printing speed and adjust the distance between the at least one print head and the at least one surface of the glass via the distance-maintaining means.

2. The device for printing on glass according to claim 1, wherein the at least one print head is of the quick loading and unloading type.

3. The device for printing on glass according to claim 1, wherein the distance-maintaining means are at least one of a system for constraining the glass according to a predetermined shape a system for scanning the surface of the glass to record a shape thereof and a distance sensor carried by the printing tool.

4. The device for printing on glass according to claim 1, wherein the control means consist of at least one of a microcontroller, a processor, a microprocessor, a digital signal processor, a field-programmable gate array, an application-specific component, a computer, comprising software configured to control the robot, the printing tool and the distance-maintaining means.

5. The device for printing on glass according to claim 1, wherein the at least one robot is configured to move the at least one print head according to an adjacent strip scanning pattern.

6. The device for printing on glass according to claim 1, comprising a single robot and a gantry, the robot being attached by the base thereof to the gantry so that the base is arranged above the holder.

7. The device for printing on glass according to claim 1, comprising two robots.

8. The device for printing on glass according to claim 7, wherein each robot performs printing on one half of the at least surface of the glass.

9. The device for printing on glass according to claim 1, further comprising at least one additional print head and means for changing the at least one print head configured to replace the at least one print head with the at least one additional print head.

10. A machine for printing on glass, comprising, arranged successively:
a glass loading station;
a glass washing station;
an optional glass scanning station;
a glass surface preparation station;
a printing station equipped with a device for printing on glass according to claim 1;
a drying station;
a control station;
an unloading station; and
two adjacent stations being connected by glass conveying devices.

11. The machine for printing on glass according to claim 10, further comprising a post-treatment station between the drying station and the control station.

12. A method for printing on glass implementing a device for printing on glass according to claim 1, comprising:
loading the holder with a glass article on at least one surface of which printing is to be performed;
printing on the surface of the glass article;
unloading the printed glass article.

13. The device for printing on glass according to claim 3, wherein the system for constraining the glass according to a predetermined shape comprises suction cups.

14. The device for printing on glass according to claim 5 wherein the at least one robot is configured to move continuously in two different directions over two adjacent strips to reduce printing time.

15. The device for printing on glass according to claim 7, wherein bases of the robots are arranged at the same height as the holder and on either side of the holder.

16. The device for printing on glass according to claim 9, wherein the means for changing the at least one print head is carried out by pneumatic or magnetic loading and unloading.

17. The machine according to claim 10, wherein the glass conveying devices are rollers or a conveyor belt.
